(19) United States
(12) Patent Application Publication
(10) Pub. No.: US 2006/0253570 A1
(43) Pub. Date: Nov. 9, 2006

(54) Self-organizing sensor node network

(76) Inventors: Pratik Biswas, Morgansville, NJ (US); Yi Zou, Columbia, SC (US); Shashi Phoha, State College, PA (US); Krishnendu Chakrabarty, Chapel Hill, NC (US); Parameswaran Ramanathan, Madison, WI (US); George Kesidis, State College, PA (US); Niveditha Sundaram, Madison, WI (US); Lun Tong, Madison, WI (US)

Correspondence Address: Douglas L. Wathen;Gifford, Krass, Groh, Sprinkle,, Anderson & Citkowski, P.C., PO Box 7021, Troy, MI, 48007-7021, US

(21) Appl. No.: 11/338,569

(22) Filed: Jan. 24, 2006

Related U.S. Application Data
(60) Provisional application No. 60/646,735, filed on Jan. 25, 2005.

(51) Int. Cl. G06F 15/173

(52) U.S. Cl. 709/224

(57) ABSTRACT

An improved network of sensor nodes can self-organize so as to reduce energy consumption and/or improve coverage of a surveillance field. Nodes within the network may be dynamically activated or deactivated so as to lengthen network lifetime and/or enhance sensor coverage of the surveillance field.

### REFERENCE TO RELATED APPLICATION

This application claims priority of U.S. Provisional Patent Application Ser. No. 60/646,735, filed Jan. 25, 2005, the entire content of which is incorporated herein by reference.

### STATEMENT OF GOVERNMENT SPONSORSHIP

The research carried out in connection with this invention was supported by the Defense Advanced Research Projects Agency (DARPA) and managed by the Army Research Office under Emergent Surveillance Plexus MURI Award No. DAAD19-01-1-0504; ONR Grant No. N66001-0-1-8946; and U.S. Army Grant No. DACA72-00-C-0021. The U.S. Government may have rights in this invention.

### FIELD OF THE INVENTION

The present invention relates to self-organizing systems, such as a sensor node network.

### BACKGROUND OF THE INVENTION

Sensor node networks can be used to monitor a surveillance field, for example by tracking objects such as vehicles within the surveillance field. However, it may not be possible to deploy each node into an optimal location within the surveillance field. A large number of nodes can be deployed to ensure coverage, but this leads to inefficiency and wasted energy, due to overlapping coverage.

### SUMMARY OF THE INVENTION

Methods and apparatus are described by which a number of sensor nodes (“nodes”) can self-organize so as to reduce energy consumption or improve coverage of a surveillance field, establishing communication between the nodes, estimating a location for each node within the network, determining a coverage of each node, deactivating any redundant nodes (i.e. those that only provide coverage also provided by other nodes) and repositioning nodes if necessary. The deactivation of nodes reduces energy consumption of the network, for example by reducing the number of inter-node communications.

Node location can be estimated using a sub-set of nodes having a global positioning system (GPS), with other node locations being established relative to these nodes. Hence, absolute locations can be established for a first group of nodes, each having a GPS, and relative locations established for a second group of nodes not so equipped. A base unit may also be provided, to provide long-range communication to a remote monitoring location, for example to transmit data out of the surveillance field. A second sub-set of nodes may be mobile nodes.

A reduced number of nodes needed to provide the same coverage and connectivity of the surveillance area as the original deployment can be selected by switching off the redundant nodes with full overlapping coverage. Nodes may also be deactivated to reduce power consumption while retaining a minimum acceptable degree of coverage. Mobile nodes may further be provided which reposition themselves to improve coverage and/or reduce energy requirements of inter-node communications, as a tradeoff between communication and surveillance tasks. One or more mobile nodes may reposition themselves so as to reduce communications energy requirements.

An improved monitoring system comprises a plurality of nodes, nodes having a sensing capability, communication with other nodes, computation ability, and (optionally) mobility. The plurality of nodes forms a communications network, the mobile nodes moveable within the surveillance field so as to reduce communication energy requirements of the monitoring system, or to improve coverage. The self-configuration of the system can take into account known or estimated paths of objects to be tracked through the surveillance field.

An example improved system includes a protocol for self-organizing a node network for tracking, a location estimation strategy that works even where not all nodes have GPS capabilities, state management of nodes in a dense node network, and a mobility strategy that compromises between a surveillance task and the goal of minimizing communication energy.

### BRIEF DESCRIPTION OF THE DRAWINGS

FIG. 1 is a flow chart of a method according to the present invention;

FIG. 2 is a flow chart of a method for optimized deployment of nodes;

FIG. 3 is a flow chart of a target tracking method;

FIG. 4 shows a high-level architecture of a test-bed used to verify protocols;

FIG. 5 shows a more detailed architecture of a test-bed;

FIG. 6 illustrates a software scheme for the test bed; and

FIGS. 7A and 7B show the results of simulated tracking of a target for an initial and optimized sensor network.

### DETAILED DESCRIPTION OF THE INVENTION

Embodiments of the present invention relate to self-organizing sensor networks. Self-organizing node networks may be built from a number of sensor nodes (which may be a large number) that may be deployed spontaneously and randomly, but can assemble themselves into an impromptu network, be aware of their own capabilities and their environment, optimize their own resource usage, dynamically adapt to device failure and degradation, manage their own movements and react to the changes in task and network requirements, without any appreciable centralized management.

Self-organization in node networks can be established to enable and/or enhance one or more of the following: sensing capabilities including coverage; resource and energy management, communications; cooperative signal processing; redundancy and recovery; and network lifetime. Hence, self-organization of a node network can be an evolutionary process, where the attributes (information, energy, resources, redundancy, etc.) and capabilities (sensing, awareness, configuration, recovery, adaptation, etc.) of the network are spontaneously enhanced, through inherent characteristics of the constituent nodes and without needing appreciable external intervention.

A novel self-organizing protocol for integrated surveillance is described in detail. In this specification, the term “protocol” refers to a protocol according to an example of the present invention, such as a self-organizing protocol. However, methods and apparatus described are exemplary, and are not intended to be limiting. Equivalent methods and apparatus can be used, different combinations of features used according to the desired application, and not all features described need be used.

A protocol according to an example of the present invention allows self-organization of a randomly deployed node network, with an arbitrary number of static and mobile nodes. A priori track information may be used to ensure that there are enough nodes, in the area where the target originally appeared and moved, to detect the target and relay the information if it were to reappear. A priori knowledge about possible target trajectory may include a training path from a past track (training pattern) or an estimated target track (from image analysis) or a predicted track (based on extrapolation). If the initial random deployment guarantees complete coverage and connectivity then this becomes redundant and the protocol is able to self-organize the network dynamically in real-time for future tracking.

In one example, a large number of nodes are deployed into a surveillance field. Nodes include sensor nodes with sensing capabilities, wireless communication, and computation capabilities, but may also include nodes having features such as longer distance communication, absolute localization using a GPS, mobility, or some combination. Acoustic sensors can be used to sense vibrations from vehicles, people, or other possible targets. The majority, such as 90 percent, of the sensor nodes are low cost, with low power and limited computation ability. A minority may have GPS, mobility, long distance communication, or enhanced computation ability.

The nodes communicate with each other, and an ad hoc sensor network is formed. Different nodes may enter or leave the network, leaving or entering a sleep (or inactive) state, depending on the coverage requirements of the sensor network (related to the ability of sensors to detect a target within the surveillance field) and communications requirements (no group of sensors should be in a communications island separated from the remainder). The lifetime of the network can be maximized by having sensor nodes enter an inactive state while maintaining acceptable levels of sensing coverage and connectivity.

In one approach, the surveillance field is divided up into portions, for example by overlaying a grid that divides the surveillance field into grid squares. A number of nodes are deployed into the surveillance field. The nodes self-reconfigure so that there is a minimum acceptable number of nodes per portion, for example one or two nodes per grid square. As active nodes become low in power, or otherwise disabled, previously inactive nodes may be dynamically activated to take their place. Mobile nodes may also be provided to help optimize network connectivity and/or sensor coverage.

As a target, such as a field, traverses the surveillance field, a signal from the target is detected by a node. In the examples described, the signal is an acoustic signal (such as engine noise or step vibration), though the invention is not limited to acoustic signal detection. Nodes close to the target detect a stronger signal, whereas nodes distant from the signal detect a weaker signal, or do not detect the signal above ambient noise. Nodes within a node cluster (a subset of the nodes proximate to the target) collaborate for improved target detection and monitoring. As the target traverses the surveillance field, the collaborative cluster effectively moves with it. Previously inactive nodes can be activated when the target is proximate. This dynamic reconfiguration of the sensor network as the target moves allows enhanced target tracking while still providing an increased network lifetime. The node cluster elects a leader, or cluster head, using a voting/balloting technique, the leader acting as a proxy for the entire cluster. As the cluster moves, a new cluster head is elected, and data may be transferred to the new cluster head. The speed and direction of the target can be determined from the cumulative data accumulated by the node clusters. Cumulative data may be passed from cluster head to cluster head, and finally transmitted to a central observer. Data may be transmitted from the network to a central observer, or stored until retrieval by, for example, a vehicle within transmission range such as an aircraft.

A cluster leader may be elected by a balloting technique, using communications over the network, with parameters such as battery life, trustworthiness of sensors, probable direction of target, or other parameter used. The closest point of approach of the target to any node can be determined from acoustic signal detection, with a cluster defined around this closest point. The cluster may further include nodes activated based on their proximity to the target.

A subset of nodes may be mobile. Nodes may be deployed randomly, so that there are portions of the surveillance field that have no coverage. There may also be islands cut off from communication with the rest of the network. Mobile nodes may then move to ensure a minimum level of coverage across the surveillance field, and/or to ensure or enhance network connectivity. A simulated annealing algorithm can be used to generate possible movements of the mobile nodes.

Nodes may be localized (i.e., their locations determined) by including a minority number of nodes having a global positioning system (GPS) for determination of absolute position. For example, there may be approximately 10 percent or less of the nodes with GPS. Having all nodes GPS equipped would increase the cost, complexity, and power requirements of the network. The remaining nodes determine their location relative to the GPS-equipped nodes, for example using triangulation methods, such as methods using timing differences in signals received from a plurality of GPS nodes.

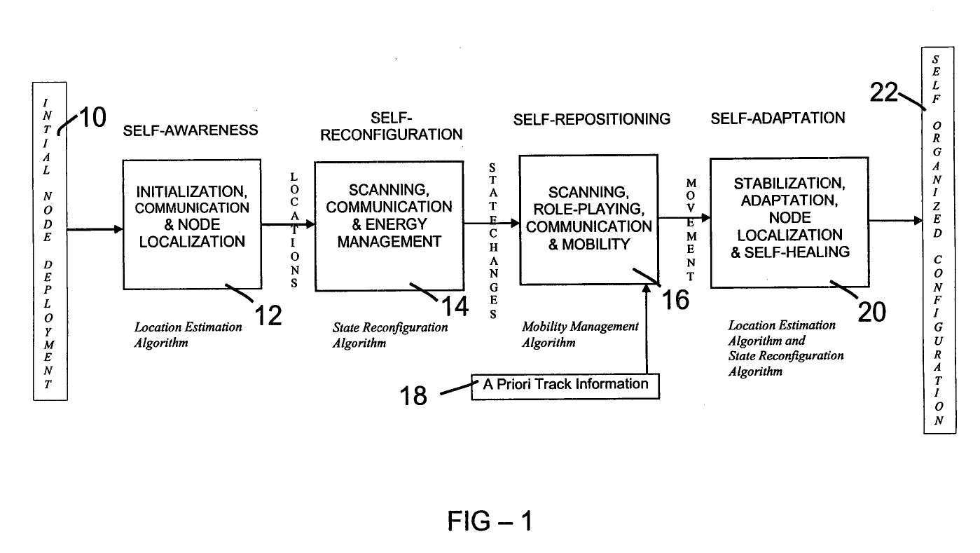

FIG. 1 illustrates a flow chart of an example method (a protocol) according to the present invention. The protocol comprises four phases; self-awareness, self-reconfiguration, self-repositioning, and self-adaptation. Box 10 represents an initial deployment of the nodes within a surveillance field. Box 12 represents the self-awareness phase, including initialization of the nodes, establishment of a communication network so as to form a sensor node network, and localization (establishing locations) for the nodes. Box 14 represents the self-reconfiguration phase, including scanning, communication, and energy management. Box 16 represents the self-repositioning phase, including scanning, role-playing, communication, and mobility. Box 18 represents providing a priori track information. Box 20 represents the self-adaptation phase, including stabilization, adaptation, node localization, and self-healing. Box 22 represents achievement of a self-organized configuration. The self-awareness, self-reconfiguration, self-repositioning, and self-adaptation phases are described in more detail below

Phase 1, Self-awareness: This phase comprises initialization, communication and node localization. Upon power up, the network runs a discovery routine, whereby nodes exchange messages to establish their local neighborhood and estimate their own locations based on the positions of their static neighbors. A Location Estimation Algorithm (LEA) used assumes the presence of a number of nodes, with GPS capabilities, whose locations are accurately known. Each node location estimate can be modeled as a rectangle. Connectivity-induced constraints can be used to localize a node and non-neighbor (neighbor of a neighbor) relationships exploited to improve the accuracy of the node location estimates.

Phase 2, Self-reconfiguration: This phase comprises scanning, communication and resource/energy. management prior to the actual arrival/detection of the target. Specifically, it ensures that the network deploys the minimal number of nodes to provide the same coverage and connectivity of the surveillance area as the original deployment, by switching off the redundant nodes with full overlapping coverage. The State Reconfiguration Algorithm (SRA) runs in two stages: the first stage is used for each node's sensing coverage evaluation, while the second stage is used for node state reevaluation and connectivity checking for the overall network. It employs a token exchange mechanism between any pair of neighbors to loop through the network, as each node calculates/recalculates its coverage redundancy and ensures node connectivity. Consequently, some nodes reconfigure their states to active while others are set to an inactive (or sleep) state. This phase may provide an energy-efficient configuration for scanning with possible fault-tolerance (if there were coverage redundancy in the original deployment) but does not necessarily guarantee that this would be a better configuration for tracking when the target follows a certain trajectory. This phase allows maximization of the lifetime of the network.

Phase 3, Self-repositioning: This phase comprises scanning, role-playing, communication and mobility during actual target surveillance. Specifically, it demonstrates node mobility as a tradeoff between surveillance and communication tasks when a target follows a preconceived (training pattern) or an evolving trajectory. Some nodes, close to the track, act as source nodes emitting target information, which gets transmitted through a host of intermediate relay nodes (active nodes from the previous phase) to a more powerful node, assuming the role of a sink node or a base station. During this process, as the origin of communication moves from one source node to the next, some of these intermediate relay nodes reposition themselves to achieve an energy-efficient configuration, vis-à-vis the training/evolving path. The Mobility Management Algorithm (MMA) uses a distributed version of simulated annealing. A node moves either when the sum of power consumption at the new position and the moving cost (power required for movement) is less than the power consumption at the old position or when the probability of acceptance (as being globally successful) of the move, based on the local power loss, is greater than a uniformly generated random number. As the local power loss increases with time, the freedom to move gets effectively diminished. If the optimization is successful, the final solution is a global minimum.

Phase 4, Self-adaptation: This phase comprises network stabilization, network adaptation, node localization (learning) and self-healing (if necessary). Specifically, node mobility comes to a halt reaching a stable and ideally optimal configuration, mobile nodes adapt to their new neighborhoods by adjusting the location estimation algorithm (network/node behavior of phase 1) to account for non-static neighbors and then use this modified algorithm to learn their new positions. This phase may also contain self-healing. If a node dies (becomes non-functional), for example on account of mobility or failing to adjust to its new neighborhood, or if the coverage is severely broken by node mobility in the previous phase, then the network can adapt the state reconfiguration algorithm (of phase 2) and switch on the nearest inactive node(s) (from phase 2) to replace the dead node and/or resume coverage.

The protocol can be useful in self-organizing a node network for tracking targets, one or more targets at a time, for example targets that traverse similar paths, such as a vehicle convoy, or when the nodes can assume the existence of a target path that is yet realistically unknown.

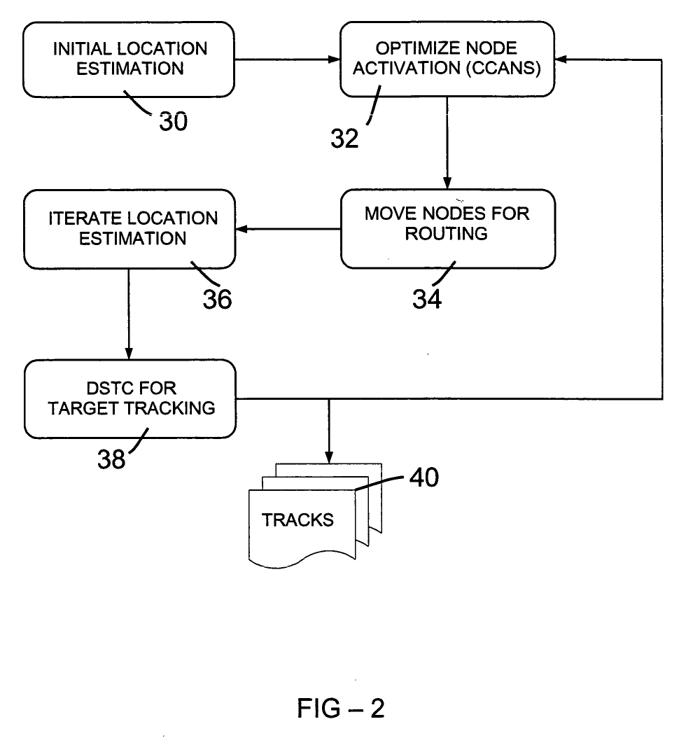

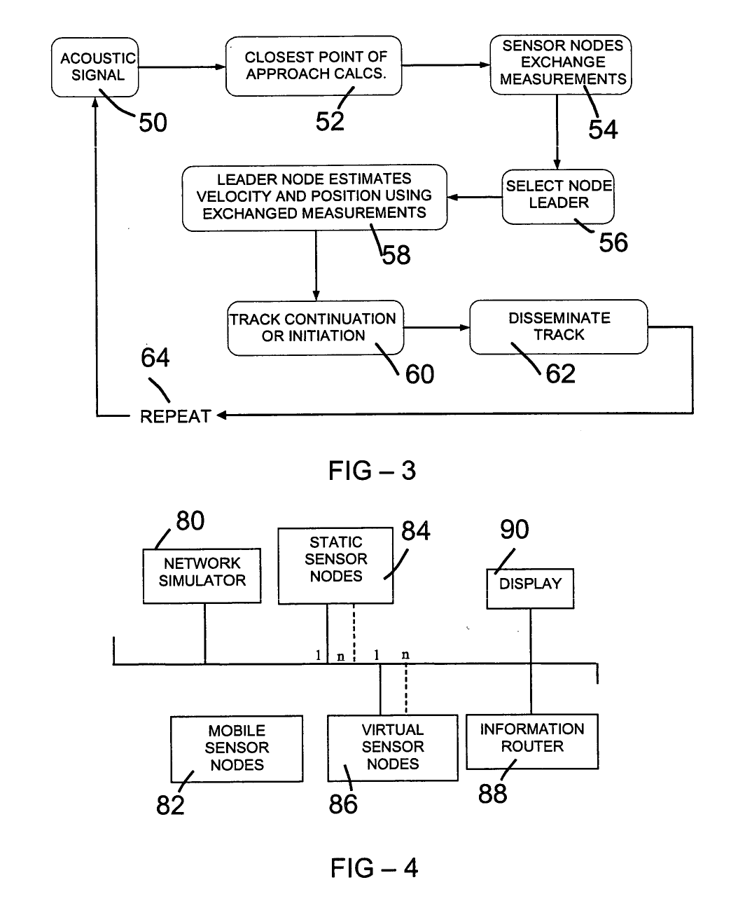

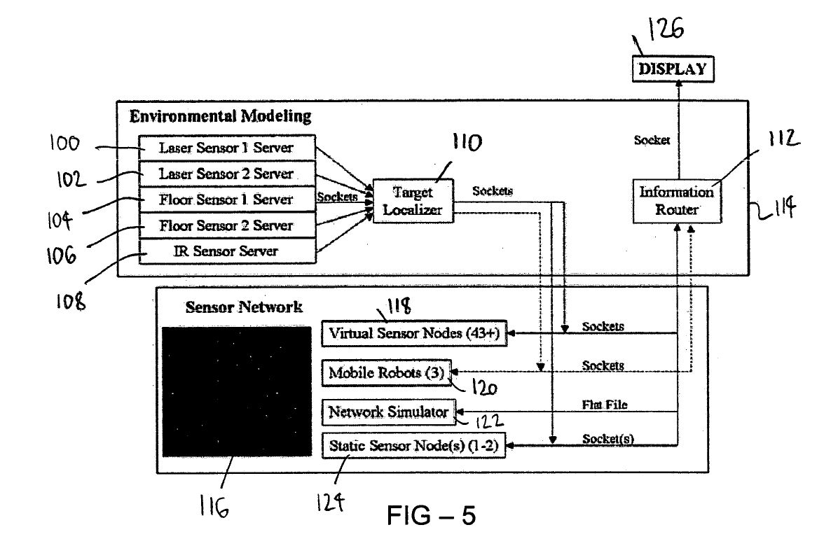

FIG. 2 illustrates a simplified control flow for a protocol (called AESOP, An Emergent-Surveillance-Plexus Self Organizing Protocol) according to an example of the present invention. Box 30 represents an initial location estimation. Box 32 corresponds to achieving an optimized node activation using a Coverage and Connectivity based Active Node Selection (CCANS) algorithm. Box 34 corresponds to moving mobile nodes for enhanced routing. Box 36 corresponds to iterating location estimates. Box 38 corresponds to target tracking using a DSTC (Dynamic Space Time Clustering) target tracking algorithm based on event clustering, such as discussed below in relation to FIG. 3. Files 40 correspond to determined tracks for targets.

The determined tracks can then be used to further optimize node activation, as represented by the arrow from box 38 to box 32. The determined tracks may correspond to roads, tracks, or other defined or preferred routes for target objects. This data may replace or augment any a priori track information.

Further details of the Algorithms

LEA: Location Estimation Algorithm

The Location Estimation Algorithm allows nodes to exchange messages to establish their local neighborhood and estimate their own locations based on the positions of their static neighbors. It assumes the presence of a number of nodes, with GPS capabilities, whose locations are accurately known. Each node's location estimate is modeled as a rectangle. It uses connectivity-induced constraints to localize a node and exploits non-neighbor (neighbor of a neighbor) relationships to improve on the accuracy of the location estimation.

CCANS: Distributed Coverage-Centric Algorithm for Active Node Selection

The Coverage and Connectivity based Active Node Selection (CCANS) algorithm is used to reduce (and ideally, to minimize) the number of nodes deployed, while providing substantially the same coverage and connectivity of the surveillance area as the original deployment. Redundant nodes with full overlapping coverage are switched off. This algorithm runs in two stages: the first stage is used for each node's sensing coverage evaluation, while the second stage is used for node state reevaluation and connectivity checking for the overall network. The algorithm employs a token exchange mechanism between any pair of neighbors to loop through the network, as each node calculates/recalculates its coverage redundancy and ensures node connectivity. Consequently, some nodes reconfigure their states to active while others are set to inactive. The algorithm is useful in maximizing the lifetime of the network.

DAA: Distributed Annealing Algorithm for Mobility Strategy

The Distributed Annealing Algorithm (DAA) demonstrates node mobility as a tradeoff between surveillance and communication tasks when a target follows a preconceived (training pattern) or an evolving trajectory. Some nodes, close to the track, act as source nodes emitting target information, which gets transmitted through a host of intermediate relay nodes (active nodes from the previous phase) to a more powerful node, assuming the role of a sink node or a base station. During this process, as the origin of communication moves from one source node to the next, some of these intermediate relay nodes reposition themselves to achieve an energy-efficient configuration, vis-à-vis the training/evolving path.

The algorithm uses a distributed version of simulated annealing. A node moves either when the sum of power consumption at the new position and the moving cost (power required for movement) is less than the power consumption at the old position or when the probability of acceptance (as being globally successful) of the move, based on the local power loss, is greater than a uniformly generated random number. As the local power loss increases with time, the freedom to move gets effectively diminished. If the optimization is successful, the final solution is a global minimum.

DSTC: Dynamic Space Time Clustering

DSTC is a target tracking algorithm based on event clustering. It depends upon the Closest Point of Approach (CPA) of a target to the nodes in the node network. Conceptually, a CPA is a local maximum in time of the intensity of the node energy detected at the node. For acoustic and seismic nodes, it is reasonable to assume that the intensity of the signal is highest when the target is closest to the node. As each node detects a CPA event, it transmits it to all nodes in the local neighborhood. The neighborhood defines a space-time window around each node that includes all nodes within a specified radius and whose readings occur within a specified time window. The radius and the time window define the size of the neighborhood. After a set time interval, each node checks its queue of CPA events acquired from the local neighborhood. If a node finds that the local intensity is larger than the others in the queue then it declares itself as the cluster-head. It then estimates the target location as a weighted mean of the CPA positions, of all the nodes that detected the target, with the square root of CPA intensity as the weight. In addition the velocity of the target is computed using a weighted regression technique that gives both the magnitude and direction. The cluster-head then propagates this track information to the nodes that are in the neighborhood of the target's estimated direction. Fewer than 5 CPA events can bias the result, and at least 2 clusters were used to draw a track in the examples discussed below. The DSTC algorithm was used to illustrate the efficacy of the protocol.

FIG. 3 is a flow chart for a DSTC algorithm control flow. Box 50 corresponds to receiving an acoustic signal from a target. Box 52 corresponds to calculating the closest point of approach for the target. Box 54 represents to exchange of measurements between nodes. Box 56 corresponds to selection of a node leader. Box 58 corresponds to the node leader estimating the velocity and position of the target using exchanged measurements. Box 60 corresponds to initiation of, or addition to, track data for the target based on the latest velocity and position. Box 62 corresponds to dissemination of the track data (for example, to a subsequent node leader, or to a central control location). Box 64 corresponds to repeating the algorithm.

As a target passes through the surveillance field, the AESOP and DSTC algorithms can interact, so that the configuration of sensor nodes is optimized for the developing target track.

Further Features of the Protocol

The protocol can ensure that the correct location of each node is always contained within its location estimate. During self-awareness, the location estimation algorithm computes the correct location of a node to be within a rectangle, representing its location estimate. During self-repositioning the exact movement of each repositioned node is recorded. During self-adaptation, the location estimation strategy is adapted to re-compute the location of each re-positioned node by adding the exact node movement (from self-repositioning) to the estimated node position prior to its movement (self-awareness), whereas for a node that hasn't moved, its location estimate stays the same. Hence, when the protocol terminates, the location error for each node, repositioned or otherwise, stays the same as at the end of phase 1, and the correct location of each node can be always contained within the rectangle representing its location estimate.

The protocol can guarantee the same coverage and connectivity as the original deployment. During self-reconfiguration, the state management algorithm finds a coverage-centric minimal subset of active nodes that forms a Connected Dominating Set (CDS) and provides the same coverage and connectivity as the original deployment. During self-repositioning, coverage can either be broken or overlap due to node mobility.

During self-adaptation, the state management algorithm is re-run to restore coverage, while still maintaining tracking accuracy. The algorithm is adapted to switch on the nearest redundant inactive nodes in case coverage was broken due to node mobility. However, if node mobility results in complete overlapping coverage, then the algorithm inactivates the redundant node, only after ensuring that the configuration achieved during self-repositioning for energy-efficient tracking is not adversely affected. Thus the protocol ensures that the self-organized configuration, comprising a subset of nodes (not necessarily always minimum) remaining active, provides the same coverage and connectivity as minimum acceptable levels, such as those of the original deployment.

The protocol can provide an optimal configuration for tracking through node mobility by minimizing a global objective function comprising of communication and mobility costs. During self-repositioning, a distributed simulated annealing algorithm can be used to govern the mobility of nodes based on a priori target path and, in a limited sense, minimizes the total transmission costs. The intermediate relay nodes (active nodes from self-reconfiguration) between the source nodes (tracking the target) and the sink move (come closer) so that the total transmission power in the network can be reduced.

A node moves either when the sum of power consumption at the new position and the amortized cost of motion (power required for movement) is less than the power consumption at the old position or when it accepts a “bad move” locally because the move could benefit the network globally in the long run. The algorithm is distributed as the nodes make such a decision based only on the local information (traffic and neighbor positions). It has been shown in, both analytically and experimentally, that such mobility minimizes a global objective function comprising of communication and mobility costs reaching an optimal configuration over time, as the temperature cools. For the correct value of the temperature, the transmission power can quickly reach an optimal value and remain relatively unaltered. However, for the inappropriate value of the temperature, the algorithm may not yield an optimal configuration in polynomial time. In the implementation of the protocol, the optimization is bounded by a time limit (entry into phase 4). Since tracking, based on a priori knowledge about possible target trajectory, is done only during self-reconfiguration (phase 3) and there is no node mobility during self-adaptation (phase 4), the above statement is true for the protocol in general.

The protocol can result in an energy-efficient self-organized configuration for tacking a target with a priori track information. During self-reconfiguration, redundant nodes with complete overlapping coverage are deactivated. This reduces the number of active nodes remaining in the configuration for continued surveillance, resulting in the savings of the total energy consumption in the network. During self-repositioning, some of the intermediate active nodes between the source nodes (track path) and sink may move, as a tradeoff between surveillance and communication tasks, with the global objective of minimizing the energy costs (statement 3). During self-adaptation, a few inactive nodes may become active to replace dead nodes or to restore broken coverage, in the area affected by mobility.

The protocol can provide a self-organized configuration having a reduced number of nodes than the initial deployment. Some nodes may have been repositioned to provide an energy-efficient configuration (in relation to communications) vis-à-vis a priori training path. A less than ideal configuration may still result in a lesser number of nodes (redundant nodes with overlapping coverage entering an inactive mode), but where no node has moved vis-à-vis the training path (phase 3), as movement to new positions might have been found to be energy-wise globally cost-ineffective. It still yields an energy-efficient configuration, as some nodes enter an inactive mode. In the worst case scenario, when there is no overlapping coverage in the initial deployment and the node density is quite high, all the nodes remain active, none moves and the protocol results in the same configuration as the initial deployment, having the same energy consumption.

Further, it can be shown that the protocol can be NP-complete. The decision problem of the protocol can be stated in the following way. Given an initial deployment of n nodes and a priori track path, can a subset of m nodes (active) be found, such that if k, where k<m (as sources and sink are static) of them are repositioned, then the repositioned subset of m nodes tracks the same path in an energy-efficient way, while still providing the same coverage and connectivity? The theorem is proved in two steps. The protocol is first proved to be in NP. A non-deterministic guess is made of the subsets of m and k nodes, new positions assigned (through location estimation algorithm) to k nodes, and then it is verified that this new configuration of m nodes can be used to track the same path with the initial coverage and connectivity (by evaluating coverage and connectivity for all grid points) but with less energy (compared to tracking it with the initial deployment of n nodes). This can be verified in polynomial time. The protocol can be shown to be NP-hard by the method of restriction. The protocol becomes equivalent to the decision problem of CCANS (self-reconfiguration), if k is set to 0. This corresponds to the special case when there is no node movement during self-repositioning (phase 3). CCANS has been shown to be NP-complete by restricting it to the problem of deciding a minimum connected dominant set (MCDS) of a graph G with cardinality. Since CCANS is NP-complete, the protocol is NP-hard.

Thus the protocol is in NP and the protocol is NP-hard. Hence, the protocol is NP-complete. An example protocol comprises three algorithms, out of which, one (location estimation) provides approximate estimations, one (CCANS) approximates a NP-complete problem, and another (distributed annealing) solves an optimization problem, bounded by time and temperature. Consequently, the implementation of a protocol, as a whole, provides a feasible solution to a NP-complete problem.

Integrated Target Surveillance Experiment

A single node network application was used to demonstrate that a distributed node network, self-organized by an improved protocol can be used to track a real target, following expected courses, using the DSTC algorithm. Self-organization refers to the ability of a system to achieve a desired or necessary configuration without external intervention. The experiment demonstrated numerous novel aspects, such as the creation, implementation and testing of track-data association techniques, an improved protocol for self-organizing a node network for tracking, a location estimation strategy that works where not all nodes have GPS capabilities, successful state management of nodes in a dense node network, and a mobility strategy that allows a successful compromise between a surveillance task and the goal of minimizing communication energy.

The infrastructure for the test-bed provides an integrated platform comprising real nodes augmented with a simulated surveillance field. It comprises several static and mobile physical nodes, fixed nodes, virtual nodes (sensing, tracking and communicating processes) and a network simulator that can simulate a node network. Data from real world tracking is provided instantaneously to the simulated environment, where it is used, analyzed and refined through various surveillance algorithms. Results from these simulations are then fed back to the real world to enable the node network to reorganize for reinforced tracking. The results indicate that a large number of distributed and interacting nodes, with different capabilities and operating in different environments, can be incorporated in high fidelity experiments to analyze the challenging aspects of the surveillance problem through realistic application scenarios.

A test-bed was constructed, allowing an experiment that demonstrated the integration of distributed tracking algorithms and associated design features on one platform through a single application scenario.

FIG. 4 shows a high-level architecture of the test-bed, comprising a network simulator 80, mobile sensor nodes 82, static sensor nodes 84, virtual sensor nodes 86, an information router 88, and a display 90.

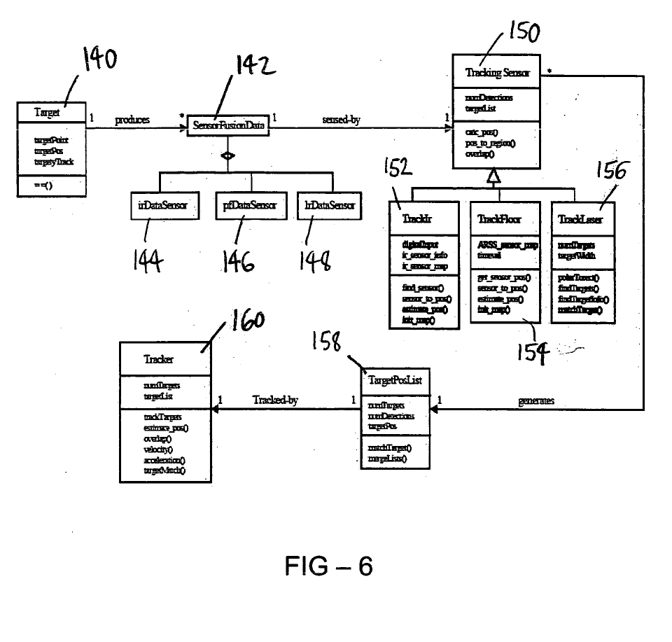

FIG. 6 shows a more detailed schematic, showing sensor servers 100, 102, 104, 106, and 108 (laser sensor 1, laser sensor 2, floor sensor 1, floor sensor 2, and IR sensor servers respectively), target localizer 110, information router 112 (the previous components forming an environmental modeler 114), sensor network 116 comprising virtual sensor nodes 118, mobile robots 120, network simulator 122, and static sensor nodes 124. The sensor network 116 communicates with the environmental modeler 114 as shown. A display 126 shows the analyzed data.

The test-bed integrates real world sensing with the simulated environment. It comprises static and mobile real nodes, sensing and tracking processes as virtual nodes running on Windows/Linux based workstations and simulated nodes running in the Network Simulator (NS). The infrastructure of the test-bed comprises nodes, autonomous nodes, display equipments, targets, wired and wireless sub-networks.

The test-bed architecture can be used to track a target in real-time using the DSTC/CPA algorithm, and such tracking can be reinforced by reorganizing nodes based on simulation results from location estimation, state reconfiguration and mobility management of nodes. An experiment runs may run in 3 stages: (1) real-time tracking, (2) self-organization simulation, based on node localization, energy and mobility management, and (3) reinforced tracking in real-time. The idea behind the “reinforced tracking with feedbacks from simulations” comes from the considerations that only a certain number of nodes can be used in an operational theater and the mobility management of these nodes can become difficult within such an area.

The following is a brief description of the functional components:

1. Node Servers: Five processes (1 per node input) collect data from laser, pressure floor, and IR sensor equipped nodes. These processes were run on Windows 2000/XP PCs.

2. Target Localizer: The Target Localizer uses node inputs, tracking nodes, tracker, and customized algorithms to determine the location of the moving target

3. Virtual Nodes: Nodes are realized as separate processes running on Windows 2000/XP PC(s). Each virtual node is modeled by a separate instance of the tracking process. These processes communicate through the Information Router so that packet dropping and other network effects can be simulated. Each virtual node has a node model and an associated CPA generator for running the DSTC/CPA algorithm. The CPA generator uses inputs from the Target Localizer to generate CPAs for the grid of virtual nodes and positions that are to be displayed on screen.

4. Information Router: The Information Router is a clearinghouse for CPA events (transmitted between the nodes), position information, network configuration, target tracks, etc. The Information Router can, for example, perform three services: inter-node communication (real and virtual), CPA/information routing to the screen and information exchange between the real node network and the Network Simulator.

5. Network Simulator: NS runs algorithms for state management, location estimation and mobility management of nodes. Nodes simulated within NS communicate with the rest of the network by means of a formatted flat-file (ASCII). The Information Router is responsible for polling that file for changes.

6. Mobile Robots: Three mobile robots act as nodes. Each is running an instance of the tracking process just as a node would. They receive CPA information just like virtual nodes. Movement instructions are communicated from NS to the robots via the Information Router. These robots communicate wirelessly with the rest of the network.

7. Static Nodes: One to two real nodes are available within the network. They receive CPA information just like virtual nodes and run their own tracking processes. The events get transmitted through the Information Router.

8. Display: A large screen (9×19″) was used to display nodes, tracks, positions, CPA events, graphs, -charts, etc.

The test bed architecture also comprises the following major interfaces (supporting different types of information exchanges)
1. Node Servers <-> Target Localizer (TCP/IP)
   i. Node Data: Boolean, Bytes, Words, Positions, etc.
2. Target Localizer <-> Virtual/Real (static) Nodes (TCP/IP)
   i. Track-info: Path (Positions), velocity, acceleration
3. Target Localizer <-> Mobile Robots (Wireless—WLAN (IEEE 802.11b))
   i. Track-info: Path (Positions), velocity, acceleration
4. Mobile Robots <-> Information Router (Wireless—WLAN (IEEE 802.11b))
   i. CPA Event: CPA time, Signal intensity, etc.
5. Information Router <-> Mobile Robots (Wireless—WLAN (IEEE 802.11b))
   i. Positions: Coordinates of the new locations (3 robots)
6. Virtual/Real (static) Nodes <-> Information Router (TCP/IP)
   i. Track: Coordinates of the target track
   ii. Positions: Coordinates of their locations
   iii. CPA Event: CPA time, Signal intensity, etc.
7. Information Router <-> Virtual/Real (static) Nodes (TCP/IP)
   i. CPA Event: CPA time, Signal intensity, etc.
   ii. Positions: Coordinates of active nodes from NS
8. Information Router <-> Network Simulator (Flat File)
   i. Track: Coordinates of 5 points from the target path
   ii. Positions: Initial configuration of the real network
   iii. Timestamps: Seconds and microseconds of the 5 points
   iv. Data Rate: Kilobits/second at the 5 positions
   v. Accessory Information: Robot speed, Robot power
9. Network Simulator <-> Information Router (Flat File)
   i. Positions: Self-organized configuration
   ii. Power: Power consumption by various algorithms
10. Information Router—Display (TCP/IP)
   i. Track: Coordinates of the target track
   ii. Positions: Locations of the real, virtual and simulated node positions
   iii. CPA Event: CPA time, Signal intensity, etc. iv. Statistics: Tracking statistics
      Node Data Fusion and Target Localization

FIG. 6 illustrates the software architecture for node data fusion and target localization. The target 140 produces sensor fusion data 142 from sensors 144, 146, and 148. The tracking sensor 150 receives track data from IR, floor pressure, and laser trackers 152, 154, and 156 respectively. A target position list 158 is generated, from which the tracker module 160 generates track parameters.

Evaluation Metrics

The following evaluation metrics can be used to evaluate a self-organizing protocol.

Protocol Simulation Metrics:

Average Location Error: This defines the average error between the actual location and the estimated location for each node. (Phase 1 and Phase 4: Self-awareness and Self-adaptation)

% of Redundancy: This defines the % of inactive nodes, from the initial configuration, left behind in the node network after the execution of the state reconfiguration algorithm. (Phase 2: Self-reconfiguration)

Average Energy Overhead: This defines the energy consumed per node during state reconfiguration (Phase 2: Self-reconfiguration). It is computed by summing the energy change for each node during the self-reconfiguration phase, over all nodes.

Energy Saved: This defines the total energy saved by the state management of nodes (Phase 2: Self-reconfiguration)

Power Usage. This defines the total power used by the active mobile nodes in the network for communication and mobility. (Phase 3: Self-repositioning).

Average Movement: defines the average distance moved by each node and the average distance per move due to its mobility strategy. (Phase 3: Self-repositioning).

Tracking Metrics:

Tracking accuracy is determined by estimating the variance V of the distance errors between the estimated track locations and actual corresponding locations of the target, where:

$$V = \frac{1}{n - 1} \sum {d}_{i}^{2}$$

Track coverage C is the fraction of the complete target path that was covered by the track, where:

$$C = \frac{\sum {t}_{i + 1}^{e} - {t}_{i}^{e}}{{t}_{1}^{p} - {t}_{0}^{p}}$$

Active tracking time is the amount of time in seconds when a node is actively estimating a target's position and velocity, and continuing a previous track or starting a new one. The accumulated active tracking times of all the nodes is compared.

Energy Consumption is the total energy used by the field of nodes to track one target through the field. This includes energy used in active and passive modes and energy used to broadcast information to other nodes in the field via the node's radio. Equations used to estimate energy consumption are given below.
Energy=CPU Energy+Broadcast Energy
CPU Energy=P_{active}*T_{active}+P_{idle}+T_{idle}
Broadcast Energy=P_{broadcast}*N_{bytes}

where: P_{active} is power used by the CPU in active phase˜300 mW; P_{idle} is power used by the CPU in idle phase ˜200 mW; T_{active} is active tracking time in seconds; T_{idle} is CPU idle time in seconds; P_{broadcast} is energy/byte of data broadcast by the node's radio˜36*10⁻⁶ Joules/byte; and N_{bytes} is number of bytes of data broadcast during the test period.

Protocol Operation in Example Scenario

Operation of an improved protocol according to the present invention in an example scenario may use the following stages:

Stage 1: (Real-time DSTC Tracking)

1) A target (mobile robot) enters combat zone

2) Virtual & real (static & mobile) nodes running the DSTC algorithm track the path of the target.

3) The track is displayed on a screen.

Stage 2: (Self-organization Simulation)

4) A Network Simulator (NS) reads the initial network configuration, creates and positions simulated nodes as per the initial deployment. Nodes are all active at the onset

5) Location Estimation algorithm determines locations of all simulated nodes (self-awareness)

6) Nodes can either remain active or become inactive (switching off node services) to minimize energy consumption and maximize node coverage yet ensuring connectivity, based on a token passing mechanism. The density of active nodes may become considerably lower than that of the initial deployment after self-reconfiguration.

7) Target traversal, following the track from Stage 1, is simulated. As each source node (close to the track) detects the target, it routes the information through a host of intermediate relay nodes (active nodes from previous step) to the sink (designated node). During this routing, some of these intermediate relays reposition themselves to achieve an energy-efficient configuration. The process is repeated till the target is detected at all source nodes (self-repositioning

8) The Location Estimation algorithm (LEA) determines new locations of all repositioned nodes. State Reconfiguration algorithm activates/de-activates some of the inactive/active nodes near the region of node movement, if necessary, to ensure continued coverage and connectivity or eliminate redundancy (self-adaptation)

9) NS outputs a flat file with the self-organized configuration comprising only the active (and some repositioned) nodes, and feeds it to the Information Router

Stage 3: (Reinforced Real-time Tracking)

10) Real node network reorganizes and tracks a second target traveling the same/similar path, using DSTC algorithm

11) The track is displayed on the screen

Experimental Results

Results are presented from an integrated surveillance experiment. It includes results from all three, stages.

Integrated Target Tracking (Stage 1)

A single target was tracked in a 30×30 (sq. ft) grid with 48 nodes: 3 mobile robots, one static node and 45 virtual nodes, running the DSTC algorithm. For real-time target tracking of a single target, the variance was 0.344 m² and track coverage was 0.45.

Self-Organization Simulation (Stage 2)

The applicability of an improved protocol according to the present invention can be shown by running a simulation in the Network Simulator (NS), with prior track information (a training pattern) and then feeding the resultant, self-organized energy-efficient configuration from the simulation to a real node network and tracking a target in real-time, closely following the training path (pattern). The self-organized configuration is applicable to any tracking algorithm that is based on the intensity of the detected signal.

Results were obtained from an integrated surveillance experiment, including NAM (Network Animator) outputs from the 4 phases of the simulation for the protocol and target paths from real-time tracking, as tracked by a distributed node network with DSTC tracking algorithm, using the self-organized configuration from the protocol.

An initial random deployment had 48 nodes, in a 30×30 (sq. m) grid, each node with a sensing range and a communication range of 10 m. Each node has an initial energy reserve of 50 J and transmission power as well as receiving power of 0.28183815 mW. A motion constant of 0.0005 W/m was used. The intermediate relays (active nodes) make a movement decision every 10 seconds during self-repositioning.

An initial random deployment included 48 nodes, including GPS nodes and 3 mobile robots. The resultant self-organized configuration had 31 active nodes, the sensor network including deactivated nodes. The positions the mobile nodes changed in the self-organized configuration, to reduce communication energy requirements.

The experiment successfully demonstrated the four phases of the protocol. Phase 1: Self-Awareness was started with 20 GPS nodes. Nodes estimated their locations using neighborhood information, three mobile robots, and other nodes. After the node localization algorithm has converged for many nodes, the average location error was 1.802288 m.

Phase 2, self-reconfiguration was then demonstrated. NAM outputs showed results from the self-reconfiguration phase. At the start of this phase, nodes had localized their positions, and network has calculated the average estimation error. In the first stage of the self-reconfiguration process, certain nodes configured their states to be active or inactive, based on an initial evaluation of the extent of overlap between their node coverage and the coverage of their neighbors. In the second stage of the self-reconfiguration process, the certain nodes reevaluated their current states to ensure that the network remains connected. The sensor network resulting from this phase included active nodes (64.6%) and inactive nodes (35.4%). Three mobile robots remained active for the next phase. Thus this phase results in 35.4% of redundancy in the initial deployment. The average energy overhead is 0.102084 J. Total energy saved through redundancy is approximately 1.735 J.

For Phase 3, self-repositioning, this phase is started with 31 active nodes remaining in the network configuration. This configuration is used to track a target that follows a training/pre-determined path. The target is detected at nodes 0, 1, 2, 3, & 4, which act as source nodes. Node 5 acts as the sink node. The three mobile robots and seven virtual mobile nodes act as intermediate communication relays that reposition themselves between the sources and the sink to obtain an energy-efficient configuration. The rest of the active nodes remain engaged in scanning. NAM outputs for this phase showed initial detection of the target, and subsequent detection at other nodes. The positions of some mobile robots and virtual mobile nodes changed, in particular with 3 nodes moving an average distance of 11.36 m per node, with an average distance of 1.75 m per move, and consumed a total power of 0.327 W for mobility and 38.335 W for communication. For example, in one case a node saved 0.012004 W by moving to a new position, while in another case a node made a probabilistic jump (for global optimization), even with a local power loss.

For Phase 4, Self-adaptation, node localization occurred during self-adaptation after some nodes moved in the previous phase. The average location error with node mobility is 1.802288 m. For this configuration, coverage and connectivity were not broken due to node mobility and remained as it was at the end of phase 2.

Reinforced Real-Time Target Tracking (Stage 3)

A single target was tracked in a 30×30 (sq. ft) grid with the resultant self-organized configuration, as obtained from the simulation, comprising 31 active nodes. The configuration for the real node network uses the 3 mobile robots and 28 real and virtual (processes) nodes running DSTC/CPA algorithm.

Single target were tracked by the distributed node network in real-time with the self-organized configuration. A goodness of fit measure (R²), point variance (Sₑ², error variance) and track coverage can be used as the error metrics to judge the tracking capabilities of the self-organized configuration, using DSTC in real-time. The R² and Sₑ² values are defined in terms of the distance errors between the actual and estimated locations and those between the center of actual trajectory and the estimated locations at various time instances during target traversal.

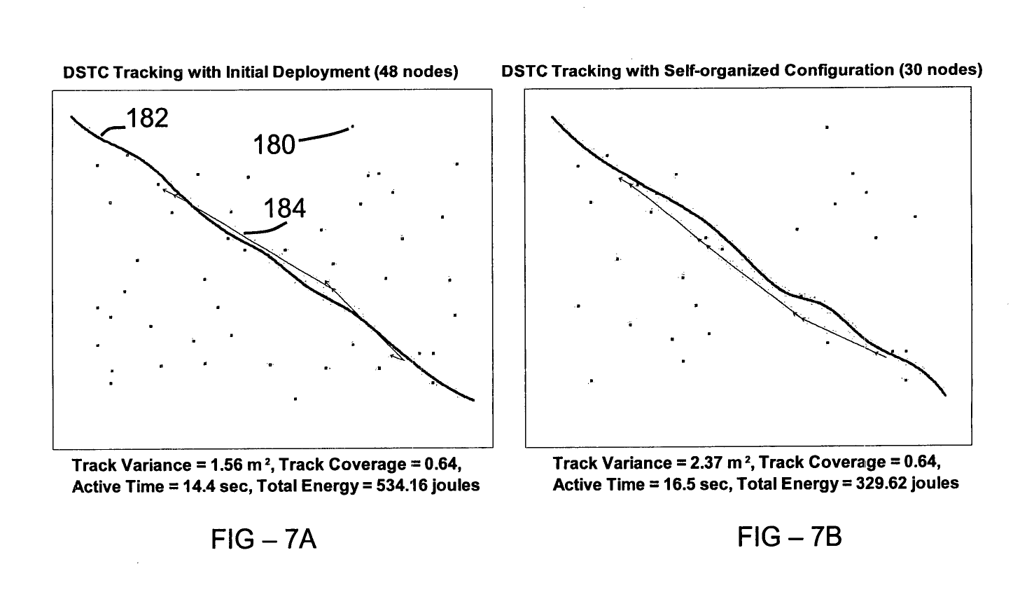

FIG. 7A shows tracking, using the DSTC algorithm, for an initial deployment of 48 nodes. The distribution of dots such as 180 represent the nodes, the thicker line 182 is the true target path, and black arrows such as 184 represent the estimated target path. The results obtained were: track variance=1.56 m², track coverage=0.64, active time=14.4 sec, total energy=534.16 joules. FIG. 7B shows results obtained for the same track using a self-organized configuration with only 30 active nodes shown of the original 48. The parameters obtained were: track variance=2.37 m², track coverage=0.64, active time=16.5 sec, total energy=329.62 joules. The total energy usage is much less with the optimized configuration of FIG. 7B, while track variance is the same.

Node Configuration

Example nodes include software, such as an operating system (OS) executed on a processor, a sensor node manager, and middleware. The node may further include one or more sensors of the same or different types, a wireless communication device, memory, a clock, a GPS module, a motor (in a mobile node), and a battery.

The OS in a sensor node may be a power aware real time operating system (RTOS) which can reduce power consumption by coordinating device usage, and allowing the node to adjust its processing speeds. The sensor node manager manages and measures the local sensor node data and provides an interface to the middleware for accessing the sensor node information.

The node middleware integrates the node with the rest of the network, allowing sensor node network applications to issue queries and command tasks into nodes, collect replies and results from nodes, fuse and use results, and monitor changes within the network, and coordinate the integration of the sensor node with the rest of the network. It may comprise a local controller, management module, communication module, mobility module, task-specific algorithms, downloaded executables and a virtual machine.

Nodes may have one or more of the following characteristics: a single node can detect a moving target but may not be able to track the target on its own; node measurements can be coordinated in time to measure target location; some nodes may have GPS, possibly as few as 10% with the remaining nodes determining their locations using message passing, triangulation, and the like; nodes can ensure connectivity and coverage through a token exchange mechanism; mobile robots may act as nodes; some nodes can move on demand; nodes may be able to construct their own command structure; and nodes may also support code mobility, such as the push/pull of data files, software code and executables.

Sensor nodes may receive one or more data inputs corresponding to acoustic, seismic, ultrasonic, optical (such as image data), video, IR or thermal image, other electromagnetic (such as electromagnetic emission), chemical (such as odor, air components, pollutants), biological (such as pathogens), temperature, other meteorological, other environmental condition, or other data arising from a tracked target. Targets may include vehicles, animals (such as humans, other mammals, pests, or other animals), or other moving objects or living beings.

Each node may have a plurality of microphones, with the microphone inputs time-stamped by a node clock. Relative time delays between detected acoustic signals can be used to estimate the direction of arrival of a noise source, for example using an approximate maximum likelihood beamforming algorithm. The location of the source may then be determined using data from a number of nodes, and this is repeated to produce a target track.

Nomadic Node Networks

In one example, nodes are positioned in the surveillance field covered by a service. Users registered for this service are equipped with hand-held devices and are themselves nodes of the network, providing additional resources in terms of energy, computational capabilities and bandwidth. A nomadic node network is therefore provided, where there are static nodes, mobile user nodes and access nodes with backbone connections. Nodes would only have the task of sensing the information from the nodes and transmitting the information to the mobile user nodes, in their vicinity. Mobile user nodes could be equipped with software agents. They would have the task of processing the information, sharing it with others and relaying it to the access node if necessary. Services can reside on user devices. Backbone connections, if needed, can be user initiated. Information would move around the network through the mobile user nodes' physical movement. User nodes could also reside on moving vehicles. This would also shift the wireless node network towards a mobile ad-hoc network (MANET), augmented by a number of inexpensive nodes.

A possible application for a nomadic node network is finding available resources within a surveillance field. An example is a parking space finding scenario, where the basic service to the user can be the assistance in finding the nearest free parking space in a city. Each parking space is equipped with an inexpensive node that is capable of notifying whether each spot is free or occupied. Self-awareness and self-reconfiguration phases can be used for location estimation of the vacant spots and for providing coverage and connectivity of the parking lot without redundancy. There can be a cluster-head for each parking lot, capable of notifying whether the parking lot has free spaces (or not) together with its geographical position, based on data aggregation from the nodes under its supervision. Each user subscribing to the service is equipped with a hand-held device that communicates both with the cluster heads and other users who have subscribed to the service. During a self-repositioning phase, the users move around the city collecting information on the parking lots, which can be stored in their devices. When two users come within communication range of each other, they exchange their knowledge and update their own information (if necessary). Random pair-wise message exchanges among the nodes can ensure message delivery. When the user queries the device about the nearest free parking lot, it provides an answer based on the data that it has in its storage. After the user finds a parking spot and occupies a space in it, a during self-adaptation phase, the cluster head reading for that lot is accordingly adjusted and communicated to the nearest mobile users.

### OTHER EXAMPLES

A method of monitoring a surveillance field using a plurality of nodes comprises the deployment of a plurality of nodes into the surveillance field, forming a communications network using the nodes, and deactivating nodes to increase network lifetime while maintaining a minimum level of surveillance field coverage. Some or all of the nodes may have a global positioning system (GPS) or other positioning system. For example, a subset of the nodes may have GPS, the remaining nodes determining a position relative to the nodes having GPS.

The plurality of nodes may include mobile and static nodes. Mobile nodes reposition themselves in order to increase the energy efficiency of the system, or the quality of the monitoring. If the target track is known or can be estimated, mobile nodes may reposition themselves to improve monitoring along the track. A target track may be determined or estimated by topography measurements (before, during, or after node deployment), location of roads and tracks, or other method.

Self-analysis by the node network by the system allows redundant nodes to be shut down, allowing coverage of the surveillance field to be maintained at a desired level while lowering the energy requirements of the system. The desired level may be the coverage after deployment, or some other desired level of coverage (for example a percentage of surveillance field area or volume).

Nodes may reposition themselves to decrease communication power requirements. If a node is destroyed, one or more nodes that had previously been shut down can be reinstated to maintain monitoring coverage or communications energy efficiency. Examples of the present invention include target tracking applications (including security applications, pedestrian detection, traffic monitoring, animal tracking, and the like), and also other monitoring apparatus, such as apparatus for monitoring meteorological, seismic, environmental, and other conditions. Examples include apparatus to monitor atmospheric pollutants, chemical plumes, and the like.

Examples described herein relate to substantially two dimensional distributions. However, examples of the present invention can be used in three dimensions, for example for monitoring of mountainous terrain, for space monitoring (of vehicles, cosmic bodies, and the like), water monitoring (of vehicles, aquatic life-forms such as fish, and the like), atmospheric monitoring (of pollution, other air components, weather conditions, aircraft, birds, and the like), monitoring of life forms using an implanted node network (for example, human physiology monitoring using a nanoprobe network), and the like.

Nodes can be deployed into a surveillance field in a substantially random fashion. Using a protocol according to the present invention, an efficient node system can then be provided. Unnecessary nodes can be shut down, permanently or temporarily, to reduce communication energy costs of the network. Nodes can also move themselves to new positions to increase the energy efficiency and/or monitoring quality of the node network. Node movement can be calculated for efficiency. Nodes may further engage in random movements in order to increase network efficiency and/or lower power requirements.

A system may include large numbers of inexpensive nodes providing information about themselves (RFID) or their environment, sophisticated mobile user devices (mobile robots, PDAs, notebooks, phones, etc), and optional powerful nodes (sinks, base-stations, gateways, etc.) with high computing power and available broadband connections.

Hence, a method of organizing a plurality of nodes to reduce energy consumption of a node network comprises establishing the sensor node network, establishing locations for each node, determining a coverage of the surveillance field by the nodes, and deactivating one or more redundant nodes, redundant nodes providing coverage also provided by other nodes, energy consumption being reduced by deactivation, and establishing an energy-efficient configuration for tracking a target, optionally using a priori information. One or more mobile nodes within the group of nodes may be moved so as to reduce communications energy requirement.

A method for providing an efficient distribution of nodes within a surveillance field comprises deploying (possibly randomly) a plurality of nodes into the surveillance field, establishing a wireless communications network through which the deployed nodes are in communications with each other, and reconfiguring the communications network to increase energy efficiency by moving one or more nodes, and by selectively deactivating nodes. Mobile nodes may be moved to improve coverage of the surveillance field and/or reduce energy requirements.

The invention is not restricted to the illustrative examples described above. Examples are not intended as limitations on the scope of the invention. Methods, apparatus (such as nodes), algorithms, programming languages, and the like described herein are exemplary and not intended as limitations on the scope of the invention. Changes therein and other uses will occur to those skilled in the art. The scope of the invention is defined by the scope of the claims.

Patents, patent applications, or publications mentioned in this specification are incorporated herein by reference to the same extent as if each individual document was specifically and individually indicated to be incorporated by reference. In particular, U.S. Prov. Pat. App. Ser. No. 60/646,735, filed Jan. 25, 2005, is incorporated herein in its entirety.

Having described our invention, we claim:

1. A method of monitoring a surveillance field, the method comprising:
deploying sensor nodes into the surveillance field;
creating a sensor network using the sensor nodes;
establishing a node location for each sensor node;
establishing a node coverage for each sensor node, the node coverage being a portion of the surveillance field monitored by each sensor node;
determining an initial surveillance field coverage from the node coverages; and
disabling sensor nodes to reduce overlap between node coverages, to provide a final surveillance field coverage for the monitoring of the surveillance field,
the final surveillance field coverage having a lower power requirement than the initial surveillance field coverage.

2. The method of claim 1, wherein determining the initial surveillance field coverage comprises:
dividing the surveillance field into portions; and
determining a number of sensor nodes in each portion.

3. The method of claim 2, wherein the portions are grid squares within the surveillance field.

4. The method of claim 2, wherein the final surveillance field coverage includes at least one sensor node in each portion.

5. The method of claim 2, wherein the final surveillance field coverage includes at least two sensor nodes in each portion.

6. The method of claim 1, wherein the surveillance field includes a predetermined track for a target object through the surveillance field,
wherein the final surveillance field coverage includes node coverage of most of the predetermined track.

7. The method of claim 6, wherein the final surveillance field coverage includes node coverage of substantially all of the predetermined track.

8. The method of claim 1, wherein the sensor nodes include mobile nodes, and creating the sensor node network further includes movement of the mobile nodes to reduce a communication energy requirements of the sensor network.

9. The method of claim 1, wherein the sensor nodes include GPS nodes having a global positioning system, and establishing a node location for each sensor node comprises:
determining absolute locations for the GPS nodes; and
determining relative locations for other sensor nodes, relative to the absolute locations.

10. The method of claim 1, wherein monitoring the surveillance field includes tracking a target object through the surveillance field,
the sensor nodes include acoustic sensor nodes responsive to vibrations produced by the target object.

11. The method of claim 10, further comprising activating disabled sensor nodes proximate to the target object when the target object is detected, so as to provide a node cluster proximate to the target object.

12. The method of claim 11, wherein the node cluster includes a node head, the node head collecting data from the node cluster.

13. The method of claim 11, wherein the node cluster moves with the target object.

14. A monitoring system for monitoring a surveillance field, the system comprising:
sensor nodes distributed over the surveillance field, the sensor nodes being in wireless communication with each other and forming a sensor network,
a first sub-set of the sensor nodes having a global positioning capability, the remaining sensor nodes determining their location relative to the first sub-set,
the sensor network dynamically activating and deactivating sensor nodes so as to increase sensor network lifetime while maintaining a minimum coverage of the surveillance field.

15. The system of claim 14, wherein a second subset of the sensor nodes comprise mobile nodes, the mobile nodes being moveable so as to decrease energy requirements of the sensor network.

16. The system of claim 14, wherein each sensor node includes:
a wireless communication module;
a processor; and
an acoustic sensor.

17. The system of claim 14, wherein the system is operable to track a target as the target moves across the surveillance field,
the system being operable to activate any deactivated sensor nodes proximate to the target so as to enhance tracking of the target.

18. The system of claim 17, wherein the system is further operable to establish a first cluster of nodes proximate to the target after detection of the target, the cluster collecting a first target tracking data set,
the system establishing a second cluster of nodes proximate to the target after movement of the target.

19. The system of claim 18, wherein each cluster of nodes has a cluster head, the cluster head being a node that coordinates collection of tracking data.

20. A monitoring system for monitoring a surveillance field, the system comprising:
sensor nodes distributed over the surveillance field, the sensor nodes being in wireless communication with each other and forming a sensor network,
a minority of the sensor nodes being mobile nodes,
the sensor network being self-organizing through movement of the mobile nodes so as to decrease energy requirements of the sensor network.
